(19) United States
(12) Patent Application Publication
(10) Pub. No.: US 2024/0155361 A1
(43) Pub. Date: May 9, 2024

(54) PRIVATE NETWORK

(71) Applicant: DISH Wireless L.L.C., Englewood, CO (US)

(72) Inventors: Paul Langer, Englewood, CO (US); In-Kyung Kim, Littleton, CO (US)

(21) Appl. No.: 18/496,690

(22) Filed: Oct. 27, 2023

Related U.S. Application Data
(60) Provisional application No. 63/424,075, filed on Nov. 9, 2022.

(51) Int. Cl. H04W 16/14; H04W 72/0453; H04W 72/56

(52) U.S. Cl. CPC H04W 16/14; H04W 72/0453; H04W 72/56

(57) ABSTRACT

Disclosed is a system including a primary access point device which, in operation, simultaneously communicates using a first unlicensed frequency band and a second unlicensed frequency band; and a secondary access point device which, in operation, receives timing information from the primary access point device using the first unlicensed frequency band and communicates with the primary access point device based on the timing information.

### BACKGROUND

In 2015, the United States (US) Federal Communication Commission (FCC) adopted rules for shared commercial use of the 3550-3700 MHz band (3.5 GHz band). The FCC established the Citizens Broadband Radio Service (CBRS) and created a three-tiered access and authorization framework to accommodate shared federal and non-federal use of the band. Tier 1 of the CBRS access and authorization framework is called the Incumbent Access Tier, which includes authorized federal users. Tier 2 of the CBRS access and authorization framework is called the Priority Access Tier, which consists of Priority Access Licenses (PALs) that can be licensed on a county-by-county basis through competitive bidding. Each PAL consists of a 10 megahertz channel within the 3550-3650 MHz band. PALs are 10-year renewable licenses. Tier 3 of the CBRS access and authorization framework is called the General Authorized Access (GAA) Tier, which is licensed-by-rule to permit open, flexible access to the band for the widest possible group of potential users.

Conventionally, organizations can create private mobile networks using commercial carriers, which does not enable the organizations to control various aspects of the commercial carriers' networks, such as usage fees, network availability, and data security, for example. Recently, enterprises have been able to create their own private 5G networks by purchasing portions of the CBRS spectrum for their own private use, which may be referred to as “Enterprise 5G”. Enterprise 5G architectures combine 5G performance with application-specific controls tailored for enterprise environments. Enterprise 5G on the CBRS spectrum, for example, does not interfere with Wi-Fi networks, which enables Wi-Fi networks and enterprise 5G networks to work together, where 5G networks are typically reserved for the most critical applications and services.

Current private networks, such as conventional Enterprise 5G networks, for example, may require a significant amount of bandwidth to be used for control channels, which reduces the throughput of such networks.

### BRIEF SUMMARY

The present disclosure teaches methods, systems, devices, and computer-readable media for forming private networks in which network throughput is not reduced by bandwidth that is used for control channels. According to the present disclosure, a group of access point devices that communicate using 5G and Wi-Fi wireless communication technologies form a private, self-optimizing network having a mesh topology. For example, the access point devices communicate over different frequency bands used for IEEE 802.11ax or Wi-Fi 6, CBRS Time Domain Duplex (TDD), and C-Band TDD communications, respectively. The access point devices can be installed anywhere and they can discover neighboring access point devices and determine the best frequency bands to use to communicate with the neighboring access point devices. The access point devices utilize licensed spectrum in one or more frequency bands, including America's Mid-Band Initiative Team (AMBIT) band (3.45 to 3.98 GHz), band n77 or C-Band (3.3 GHz to 4.2 GHz), and band n96 or Unlicensed National Information Infrastructure (U-NII) band (5.925 to 7.125 GHz) to communicate control information and to create a mesh network topology between the access point devices, which guaranties accessibility between access point devices. For example, the access point devices utilize licensed 70 to 80 MHz aggregated bandwidth using frequencies in the upper portion of the AMBIT band and the lower portion of the CBRS band using inter-band carrier aggregation (CA).

A system according to the present disclosure may be characterized as including a primary access point device which, in operation, simultaneously communicates using a first unlicensed frequency band and a second unlicensed frequency band; and a secondary access point device which, in operation, receives timing information from the primary access point device using the first unlicensed frequency band and communicates with the primary access point device based on the timing information.

### BRIEF DESCRIPTION OF THE SEVERAL VIEWS OF THE DRAWINGS

Non-limiting and non-exhaustive embodiments are described with reference to the following drawings. In the drawings, like reference numerals refer to like parts throughout the various figures unless otherwise specified.

For a better understanding of the present disclosure, reference will be made to the following Detailed Description, which is to be read in association with the accompanying drawings.

FIG. 1 is a diagram of a private network in accordance with embodiments described herein.

FIG. 2 is a block diagram illustrating an example of an access point device in accordance with embodiments described herein.

FIGS. 3A, 3B, 3C, and 3D include block diagrams illustrating additional examples of access point devices in accordance with embodiments described herein.

FIGS. 4A and 4B include block diagrams illustrating other examples of access point devices in accordance with embodiments described herein.

FIGS. 5A and 5B show examples of frequency combinations used by access point devices in accordance with embodiments described herein.

FIGS. 6A and 6B show examples configuration options for access point devices in accordance with embodiments described herein.

FIGS. 7A, 7B, 7C, 7D, 7E, 7E, 7F, 7G, 7H, and 7I show results and other information related to various computer simulations of access point devices in accordance with embodiments described herein.

### DETAILED DESCRIPTION

The present disclosure teaches access point (AP) devices that interoperate to provide a private network, which can communicate with a core network (e.g., a fourth-generation Long Term Evolution (4G LTE) network core or a fifth-generation New Radio (5G NR) network core). The AP devices utilize a control channel, which is transmitted over a wireless backhaul connection using an unlicensed frequency band (e.g., n96, 6 GHz), to exchange messages that are used to discover other AP devices and devices attached thereto (e.g., UE devices), and to determine how to route traffic within the private network using other frequency bands, which may be licensed or unlicensed.

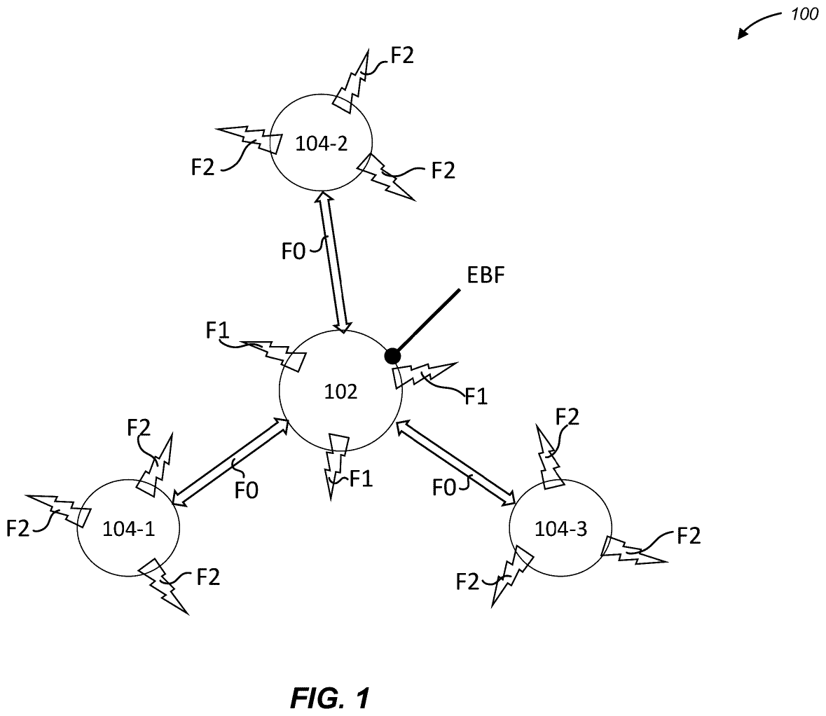

FIG. 1 is a diagram of a private network 100 in accordance with embodiments described herein. The private network 100 is provided by a plurality of access point devices, including a primary access point and one or more secondary access point devices. In the example shown in FIG. 1, the private network 100 includes primary access point device 102, and three secondary access point devices 104-1, 104-2, and 104-3. Each of the access point devices 102, 104-1, 104-2, and 104-3 communicates using a plurality of different frequency bands. Some of the frequency bands are unlicensed and some are licensed.

The primary access point device 102 communicates wirelessly using a set of one or more frequencies included in a first frequency band F0 (e.g., 5G New Radio Unlicensed (5G NR-U) band n96) for wireless backhaul connections with the secondary access point devices 104-1, 104-2, and 104-3. Also, the primary access point device 102 communicates wirelessly using a set of one or more frequencies included in a second frequency band F1 (e.g., 5G New Radio (5GNR) access frequency on a mid-band of 3.5 GHz) for wireless connections with client devices, such as user equipment (UE) devices (not shown). In addition, the primary access point device 102 communicates in wired manner (e.g., using an optical fiber connection) to an Internet Service Provider (ISP) for external backhaul feed (EBF). The primary access point device 102 uses the first frequency band F0 for gNB access supporting backhaul communications for the secondary access point devices 104-1, 104-2, and 104-3. The second frequency band F1 is used for gNB access supporting user traffic. The second frequency band F1 may include frequencies bands n48 GAA or CA-n77_n48 PAL (optionally carrier aggregation (CA) with band n46 and/or band n96).

In one or more implementations, the primary access point device 102 have the following gNB access capabilities: simultaneous operation on two frequencies (n96 and 3.5 GHz), 2 bands on 3.5 GHz with inter-band CA (n77 and n48), and 4×4 Transmit/Receive (Tx/Rx) on 100 MHz bandwidth (BW) for each frequency.

The primary access point device 102 operates as a base station (e.g., gNB) that provides connectivity between client device (not shown) (e.g., UE devices attached to the primary access point device 102 and the secondary access point devices 104-1, 104-2, and 104-3) and an Evolved Packet Core (EPC) (not shown) via the EBF. The primary access point device 102 is responsible for radio-related functions in the private network 100, for example, radio resource management, admission control, connection establishment, routing of user-plane data to the UPF and control-plane information to an access and mobility management function (AMF), and quality-of-service (QoS) flow management.

In one or more implementations, the secondary access point devices 104-1, 104-2, and 104-3 communicate wirelessly with the primary access point device 102 using a set of one or more frequencies included in the first frequency band F0 (e.g., 5G NR-U band n96) for wireless backhaul connections with the primary access point device 102. In addition, the secondary access point devices 104-1, 104-2, and 104-3 communicate wirelessly with client devices (e.g., UE devices) using a set of one or more frequencies included in a third frequency band F2 (e.g., 5GNR access frequency on the mid-band of 3.5 GHz). For example, the secondary access point devices 104-1, 104-2, and 104-3 receive user data from client devices using a set of one or more frequencies included in the third frequency band F2, and forward the user data using a set of one or more frequencies included in the first frequency band F0 to the primary access point device 102, which may forward the user data to a core network using the external backhaul feed (EBF).

In one or more implementations, the secondary access point devices 104-1, 104-2, and 104-3 have the following gNB and UE access capabilities: gNB: inter-band CA on 3.5 GHz (n77 and n48), UE: n96, and 4×4 Tx/Rx on 100 MHz BW for each frequency.

In use, when the private network 100 is set up at location, such as a building, for example, there is only one backhaul feed (e.g., Internet connection) to the building. The primary access point device 102 is installed in the building and connected to the Internet. Coverage of the primary access point device 102 can be extended adding one or more of the secondary access point devices 104-1, 104-2, and 104-3. Each of the one or more of the secondary access point devices 104-1, 104-2, and 104-3 is connected to the primary access point device 102 using a 5G NR-U link, i.e., n96. Accordingly, each of the one or more of the secondary access point devices 104-1, 104-2, and 104-3 requires only AC power for operation. Each of the one or more of the secondary access point devices 104-1, 104-2, and 104-3 has a direct connection to the primary access point device 102. Although, the private network 100 shown in FIG. 1 includes secondary access point devices 104-1, 104-2, and 104-3, the private network 100 may include only the secondary access point device 104-1, for example. If multiple secondary access point devices are used, the total traffic capacity delivered from the secondary access point devices is limited by the n96 backhaul capacity. The primary access point device 102 provides 5GNR and WiFi coverage. The primary access point device 102 can be configured such that the WiFi radio frequency (RF) is the same as 5GNR RF coverage, which obviates a need for an additional WiFi only access point.

In one or more implementations, the primary access point device 102 is connected to a Global Positioning Device (GPS) device (e.g., by a cable), and the primary access point device 102 obtains timing information based on a signal output by the GPS device. The secondary access point devices 104-1, 104-2, and 104-3 may not be connected to a GPS device. Accordingly, the secondary access point devices 104-1, 104-2, and 104-3 obtain timing information from the primary access point device 102 using the backhaul communications using the first frequency band F0 (e.g., 5G New Radio Unlicensed (5G NR-U) band n96) and perform synchronization using the timing information. For example, the primary access point device 102 and the secondary access point devices 104-1, 104-2, and 104-3 are configured to implement the Precision Time Protocol (PTP) as defined in IEEE 1588-2008 standard, for example, using Frequency Division Duplex (FDD) communications. After the primary access point device 102 and the secondary access point devices 104-1, 104-2, and 104-3 synchronize their respective clocks that can efficiently perform Time Division Duplex (TDD) communications.

Assuming that 5GNR offers equivalent or better services than WiFi, peak throughput is greater than 1 Gbps, which may require 5GNR access BW of approximately 100 MHz, and a separate BW allocation for the backhaul that is greater than 100 MHz. Downlink peak throughput for TDD band (256QAM, 30 Khz Subcarrier Spacing (SCS)) may be provided as show in Table 1 below.

TABLE 1

| | | |
|---|---|---|
| BW | DDDDDDDSUU (70%) | DDDSU (60%) |

| | | | |
|---|---|---|---|
| 100 | MHz | 1.6 Gbps | 1.4 Gbps |
| 80 | MHz | 1.3 Gbps | 1.1 Gbps |

In Table 1, the letter “D” indicates a time period used for downlink communications, the letter “S” indicates a time period used for switching communication directions, and the letter “U” indicates a time period used for uplink communications.

Per user experience can be determined by a typical access point (AP) cost vs. coverage tradeoff space. It may be easy to make 5GNR coverage much larger than a typical WiFi AP; however, per user throughput will suffer (inversely proportional to the coverage). An optimum factor K: 5GNR coverage=K*WiFi coverage may be determined. For example, K may be between 2 and 4.

In one or more implementations, the primary access point device 102 provides gNB functionality using 2× 4T4R on 100 MHz BW (with inter-band CA capability). Each of the secondary access point devices 104-1, 104-2, and 104-3 provides gNB functionality (access) using 1× 4T4R on 100 MHz BW (with inter-band CA capability), and provides UE capability (backhaul) using 1× 4T4R on 100 MHz BW. The secondary access point devices 104-1, 104-2, and 104-3 provide UE support using NRU band (n46 and n96) and 3.5 GHz (n77 and n48).

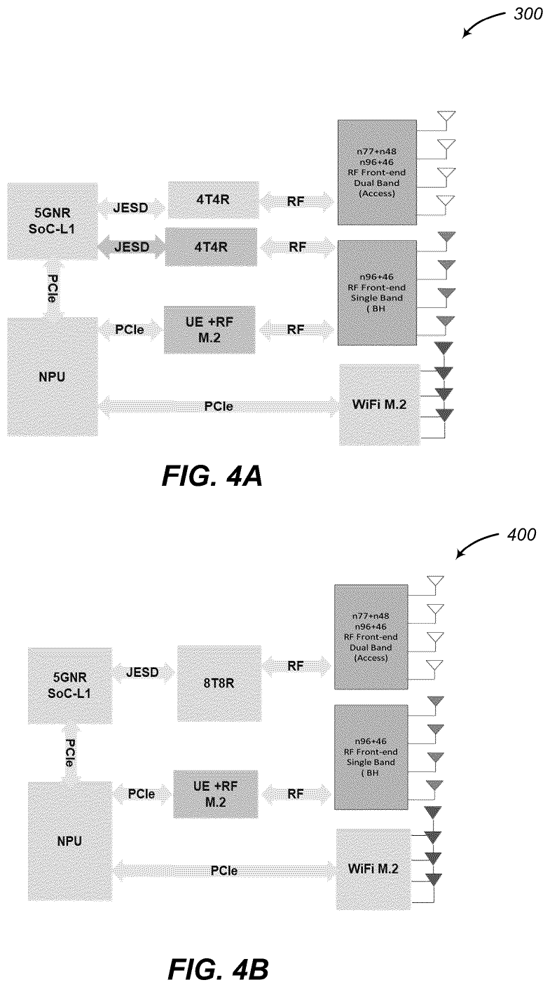

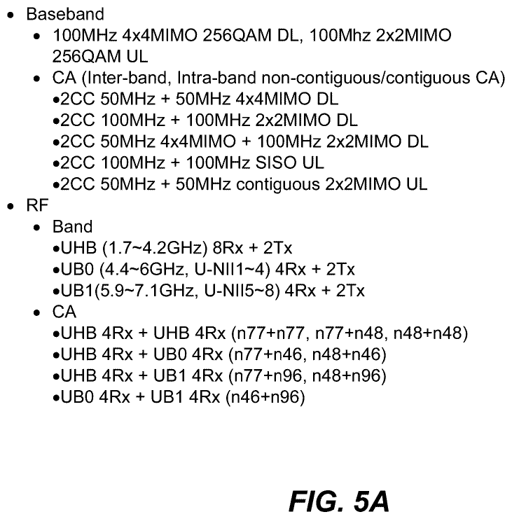

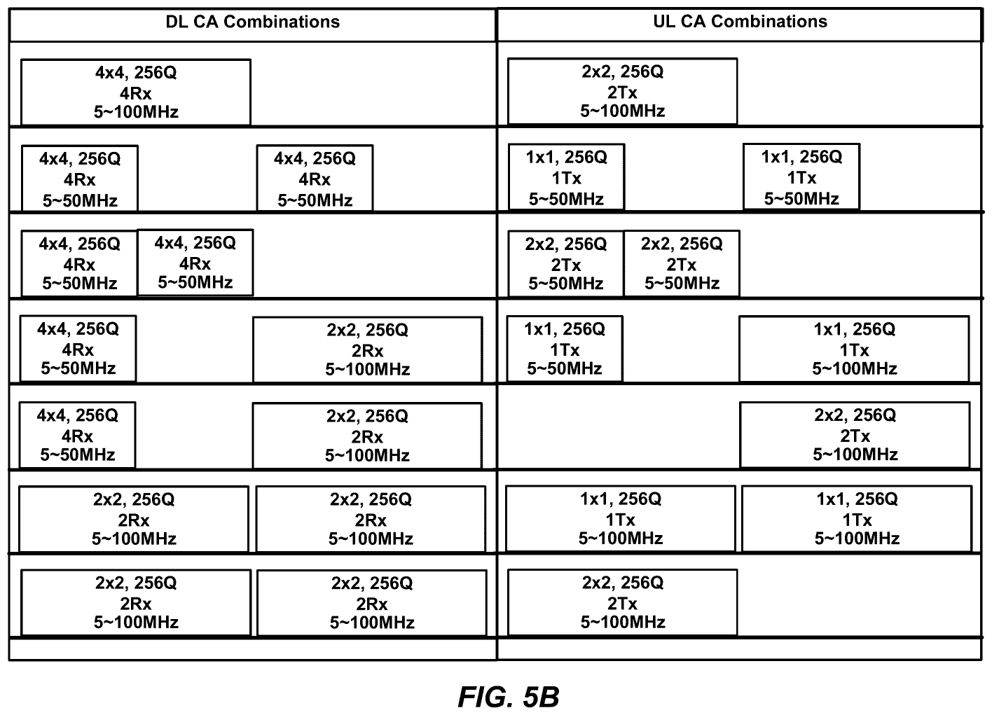

In one or more implementations, the primary access point device 102 and the secondary access point devices 104-1, 104-2, and 104-3 are configured and operated as described and shown in FIGS. 4 and 5 of U.S. patent application Ser. No. 17/859,986, entitled “Private Network”, filed Jul. 7, 2022, which is hereby incorporated by reference in its entirety.

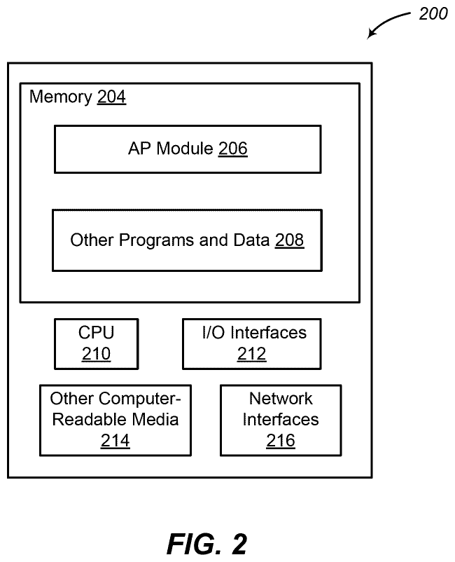

FIG. 2 is a block diagram illustrating an example of an Access Point (AP) device 200 in accordance with embodiments described herein. As explained below, the AP device 200 may be used to implement the access point devices 102, 104-1, 104-2, and 104-3 in FIG. 1.

In some embodiments, one or more special-purpose computing systems may be used to implement the AP device 200. Accordingly, various embodiments described herein may be implemented in software, hardware, firmware, or in some combination thereof. The AP device 200 may include one or more memory devices 204, one or more central processing units (CPUs) 210, I/O interfaces 212, other computer-readable media 214, and network interfaces 216.

The one or more memory devices 204 may include one or more various types of non-volatile and/or volatile storage technologies. Examples of the one or more memory devices 204 may include, but are not limited to, flash memory, hard disk drives, optical drives, solid-state drives, various types of random access memory (RAM), various types of read-only memory (ROM), other computer-readable storage media (also referred to as processor-readable storage media), or the like, or any combination thereof. The one or more memory devices 204 may be utilized to store information, including computer-readable instructions that are utilized by the one or more CPUs 210 to perform actions, including those of embodiments described herein.

The one or more memory devices 204 may have stored thereon an Access Point (AP) module 206. The AP module 206 is configured to implement and/or perform some or all of the functions of the AP device 200 described herein. The one or more memory devices 204 may also store other programs and data 208, which may include digital certificates, connection recovery algorithms, connection recovery rules, network protocols, O-RAN operating rules, user interfaces, operating systems, etc.

I/O interfaces 212 may include enhanced Common Public Radio Interface (eCPRI) ports, Antenna Interface Standards Group (AISG) interfaces (e.g., including ability to manipulate antenna features), other data input or output interfaces, or the like. Other computer-readable media 214 may include other types of stationary or removable computer-readable media, such as removable flash drives, external hard drives, or the like. Network interfaces 216 are configured to communicate with other computing devices including Radio Unit (RU) devices, User Equipment (UE) devices, and other Access Point (AP) devices. In various embodiments, the network interfaces 216 include transmitters and receivers, a layer 2 (L2) switch and physical network ports (not illustrated) to send and receive data as described herein, and to send and receive instructions, commands and data to implement the processes described herein.

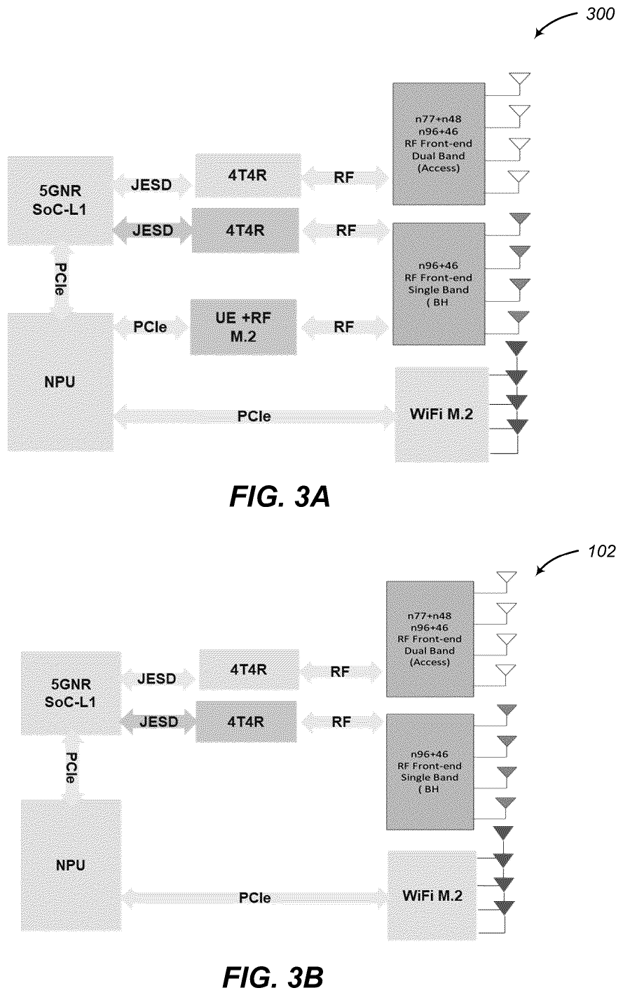

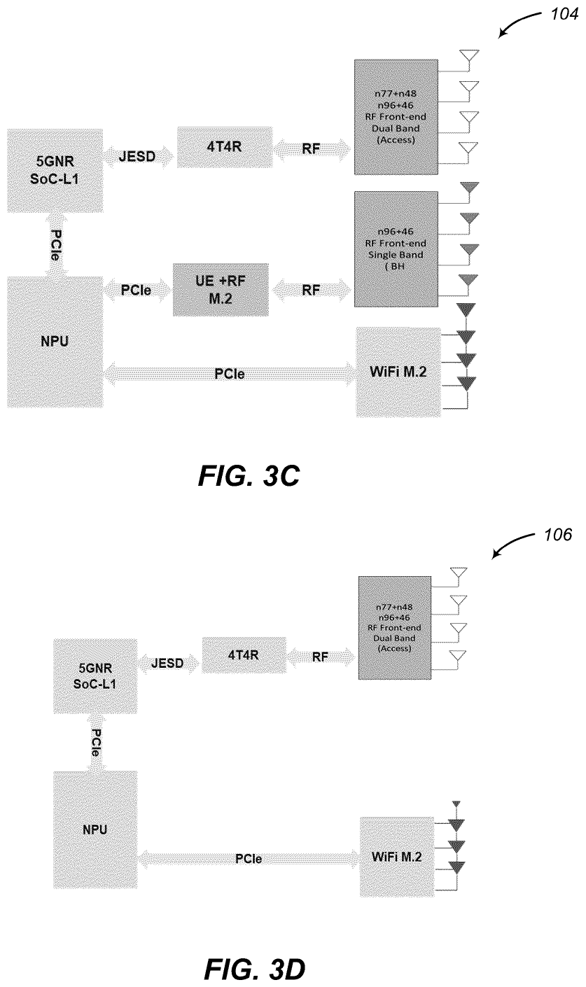

FIGS. 3A, 3B, 3C, and 3D include block diagrams illustrating additional examples of access point devices in accordance with embodiments described herein. As will be explained with reference to FIGS. 3A, 3B, 3C, and 3D, various one of the access point devices 102, 104-1, 104-2, and 104-3 in FIG. 1 can be configured using a modular design concept.

FIG. 3A shows a modular platform 300 that can be used to implement each of the primary access point device 102 and the secondary access point devices 104-1, 104-2, and 104-3 (and other access point devices) by including and configuring required components, wherein components that are not required may not be included and/or configured. The modular platform 300 includes a Network Processor Unit NPU can be connected by a first PCI Express (PCIe) bus to a WiFi processing module, which provides WiFi communications. The Network Processor Unit NPU can be connected by a second PCIe bus to a 5GNR processing module. The 5GNR processing module can be connected by a first JESD interface to a first 4T4R processing module including four transmitters and four receivers, which can be connected by a first RF interface to a first RF front end. The first RF front end provides dual band (n77 and n48, and n96 and n46) communications for access communications. Also, the 5GNR processing module can be connected by a second JESD interface to a second 4T4R processing module including four transmitters and four receivers, which can be connected by a second RF interface to a second RF front end. The second RF front end provides single band (n96 and n46) communications for backhaul communications. Additionally, the Network Processor Unit NPU can be connected by a third PCIe bus to a UE and RF processing module, which can be connected by a third RF interface to the second RF front end. Additionally, the Network Processor Unit NPU can be connected by a third PCIe bus to a UE and RF processing module, which can be connected by a third RF interface to the second RF front end.

FIG. 3B shows an example implementation of the primary access point device 102. The primary access point device 102 is implemented using the components that are shown in FIG. 3B and described above in connection with FIG. 3A.

FIG. 3C shows an example implementation of a secondary access point device 104, which can be used to implement each of the secondary access point devices 104-1, 104-2, and 104-3. The secondary access point device 104 is implemented using the components that are shown in FIG. 3C and described above in connection with FIG. 3A.

FIG. 3D shows an example implementation of a secondary access point device 106, which is similar to the secondary access point devices 104-1, 104-2, and 104-3 described above, except that the secondary access point device 106 does not include backhaul functionality. The secondary access point device 104 is implemented using the components that are shown in FIG. 3D and described above in connection with FIG. 3A. For example, the secondary access point device 106 includes the modular platform 300 shown in FIG. 3A, wherein the NPU, the 5GNR processing module, first 4T4R processing module, and the first RF front end, and the WiFi processing module are included in the modular platform 300 of the secondary access point device 106 (and the second 4T4R processing module, the second RF front end, and the UE and RF processing module are not included in the modular platform 300 of the secondary access point device 106). Accordingly the modular platform 300 can be used to implement each of the access point devices shown in FIG. 1, for example, which can reduce manufacturing costs.

FIGS. 4A and 4B include block diagrams illustrating other examples of access point devices in accordance with embodiments described herein. More particularly, FIGS. 4A and 4B show a comparison of the modular platform 300 shown in FIG. 3A and a modular platform 400. The modular platform 400 is similar in many relevant respects to the modular platform 300 described above in connection with FIG. 3A. As can be seen by comparing FIGS. 4A and 4B, the modular platform 400 includes a single JESD interface, instead of the first and second JESD interfaces included in the modular platform 300. Also, the modular platform 400 includes a single 8T8R processing modules including 8 transmitters and 8 receives, instead of the first and second 4T4R processing modules included in the modular platform 300.

FIGS. 5A and 5B show examples of frequency combinations used by access point devices in accordance with embodiments described herein. The examples shown in 5A and 5B use various carrier aggregation schemes, including inter-band, intra-band non-contiguous/contiguous carrier aggregation. As shown in FIGS. 5A and 5B, the access point devices may use various downlink carrier aggregation combinations and various uplink carrier aggregation combinations. The present disclosure is not limited by the examples shown in FIGS. 5A and 5B. Other frequency combinations are within the scope of the present disclosure.

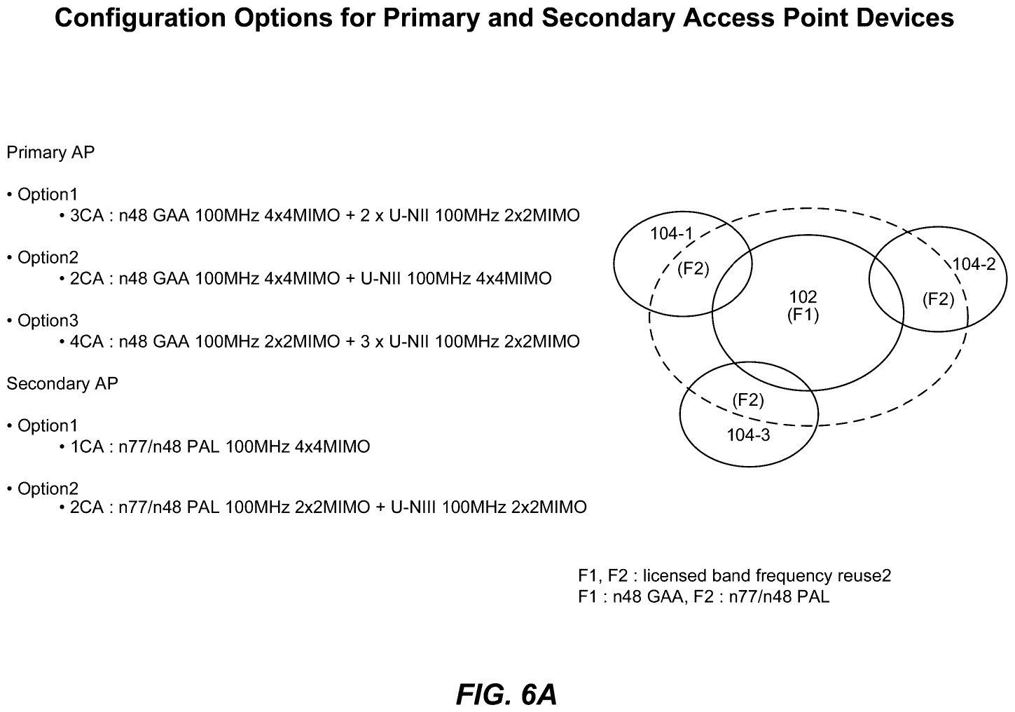

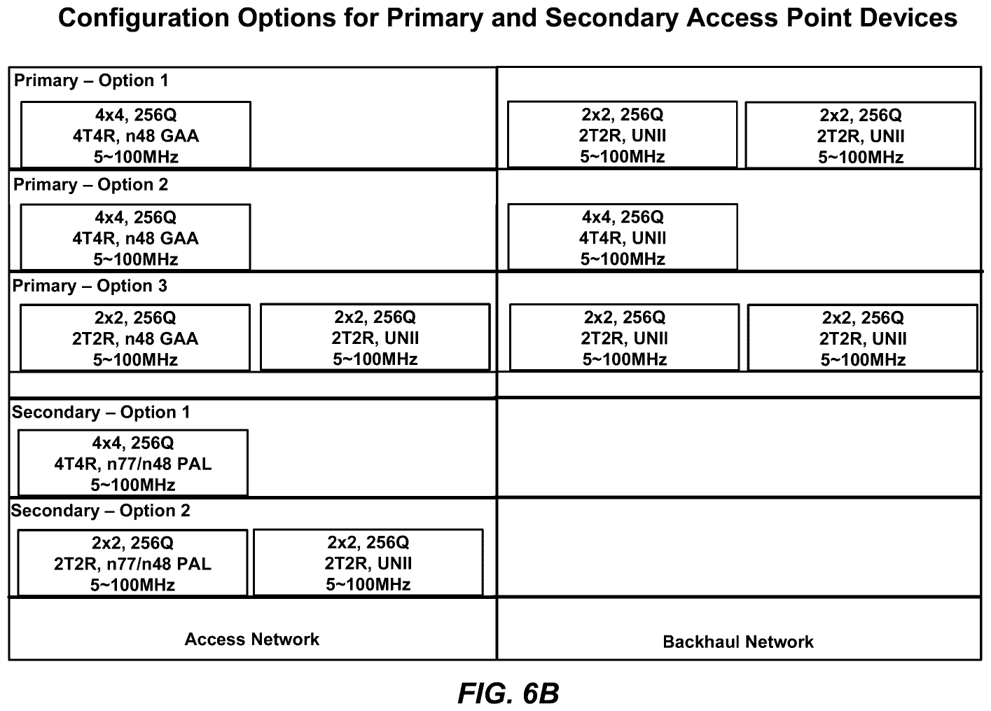

FIGS. 6A and 6B show examples configuration options for primary and secondary access point devices in accordance with embodiments described herein. FIGS. 6A and 6B show three configuration options for primary access point devices, such as primary access point device 102, for example. Additionally, FIGS. 6A and 6B show two configuration options for secondary primary access point devices, such as secondary access point devices 104-1, 104-2, and 104-3, for example. The present disclosure is not limited by the examples shown in FIGS. 6A and 6B. Other configuration options are within the scope of the present disclosure.

Primary access point device Option 3 and secondary access point device Option 2 deliver the best performance, in which 2×2 is guaranteed everywhere vs. 4×4 is not realized all the time. Such configuration requires CA (100+100 MHz) for both access and backhaul. To maintain the frequency reuse factor 2, 100 Mhz of NRU freq (n96) is aggregated. The most spectrum hungry configuration requires a total of 400 MHz BW. It is noted that the frequency frugal configurations are primary access point device Option 2 and secondary access point device Option 1.

Private networks according the present disclosure may be configured for a typical office configuration, with a typical size, a typical layout, and typical number of users. Additionally, private networks according the present disclosure may be configured to provide a WiFi competitive landscape by taking into consideration WiFi density in a typical installation (e.g., number of access point devices per 10,000 square feet), per user experience in busy hours, and coverage, especially experience around the coverage edges.

In one or more implementations, the private network 100 is a self-optimizing network (SON). After initial placement of the primary access point device 102 and the secondary access point devices 104-1, 104-2, and 104-3, the primary access point device 102 and the secondary access point devices 104-1, 104-2, and 104-3 perform a series of transmissions and measure resulting RF interference. Information regarding the measured RF interference is used by the primary access point device 102 select power levels of transmitters and configurations options for the primary access point device 102 and the secondary access point devices 104-1, 104-2, and 104-3 that improve network performance (e.g., maximize throughput, minimize delay, improve QoS, etc.).

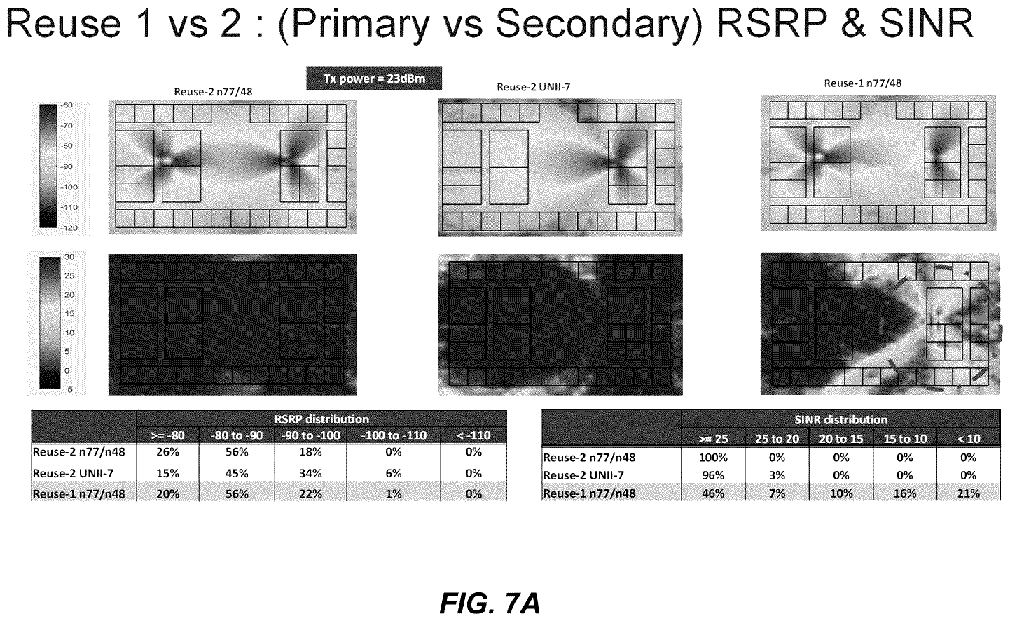

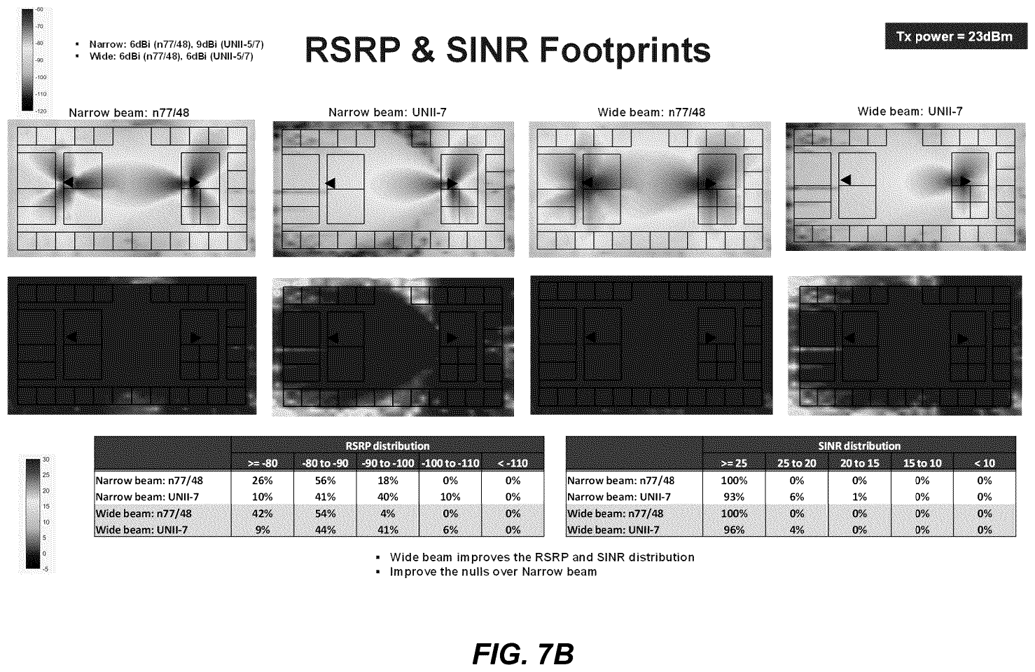

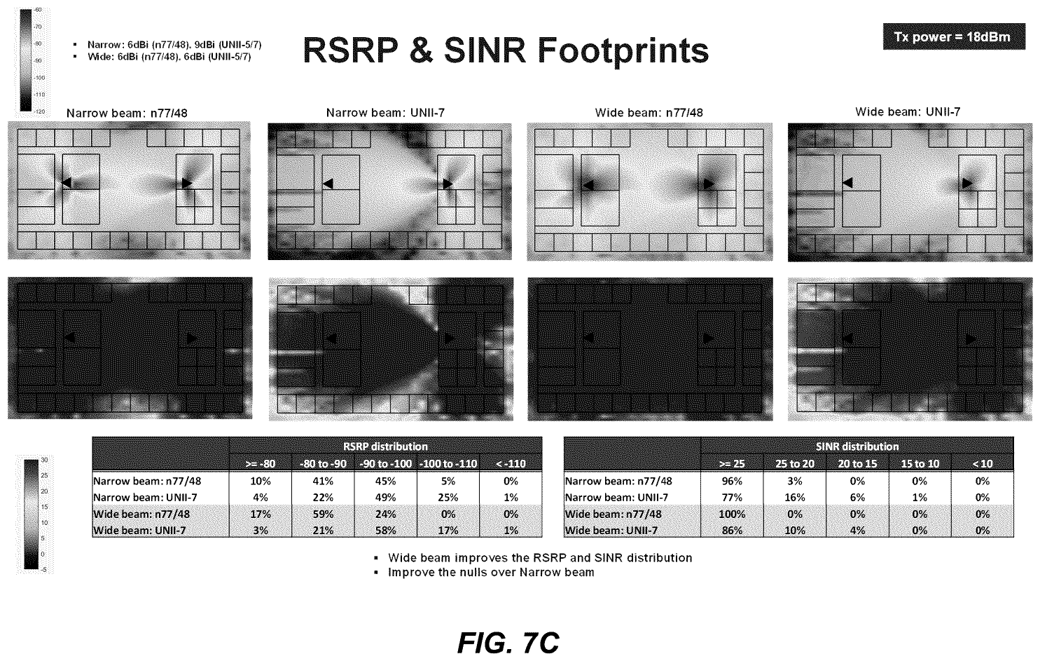

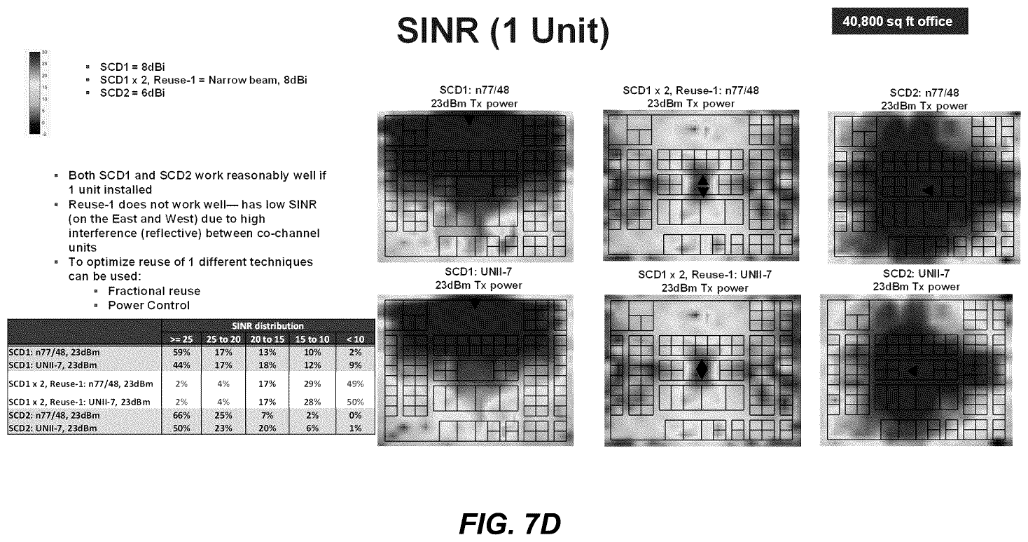

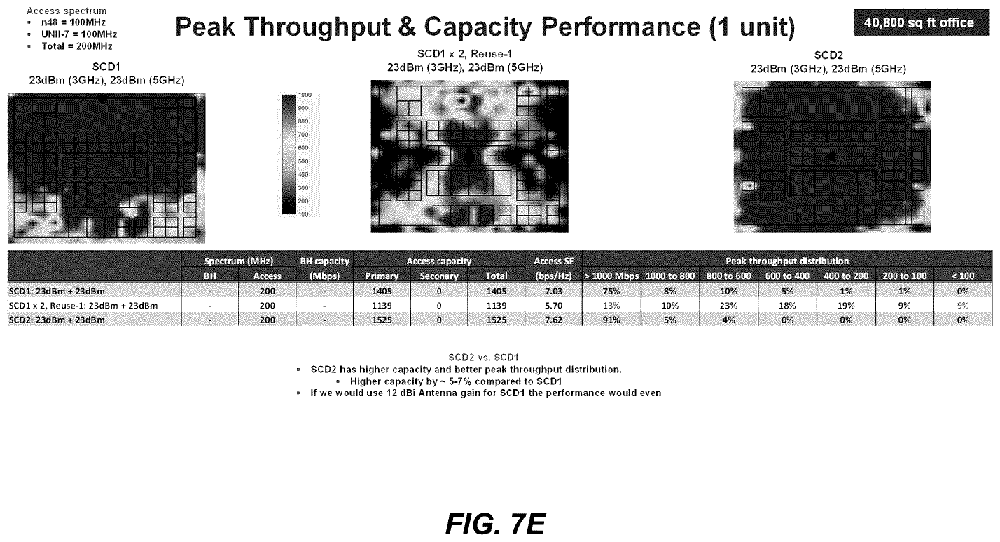

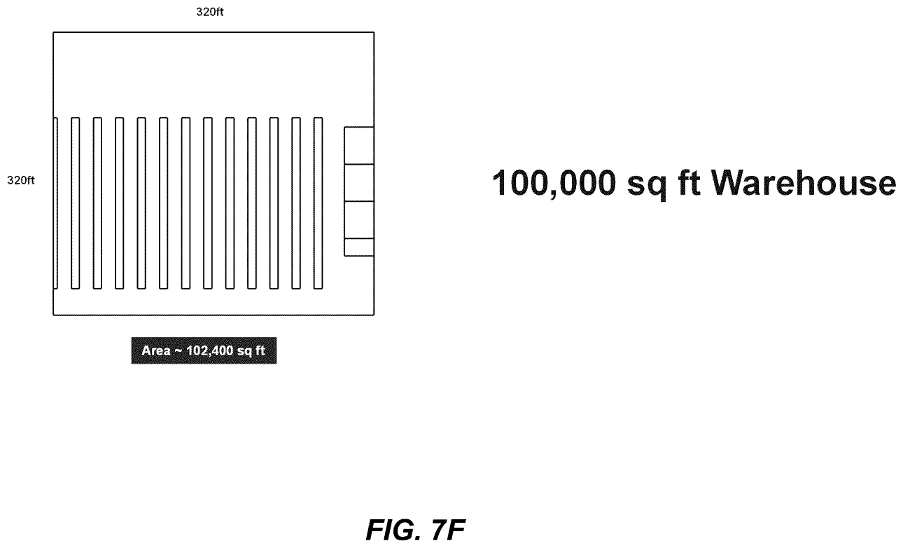

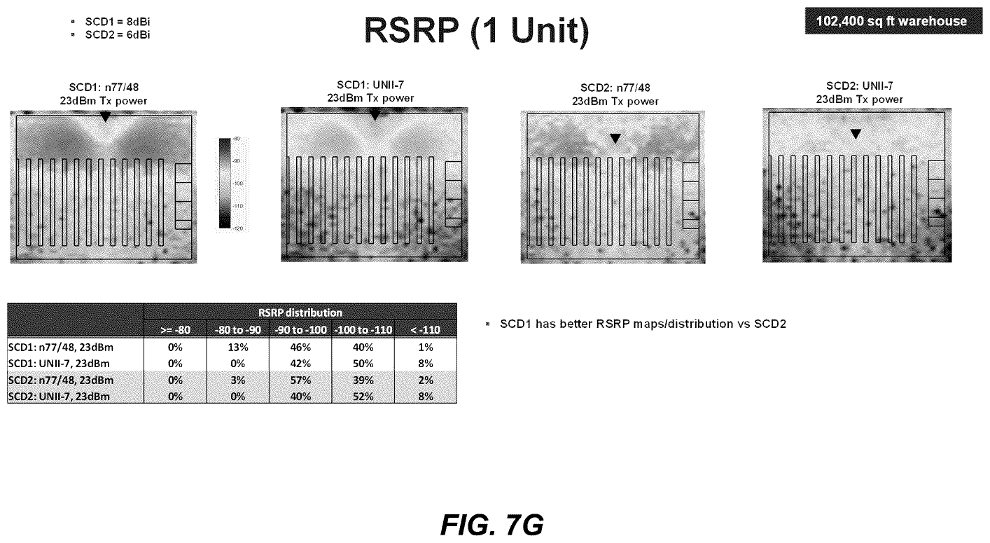

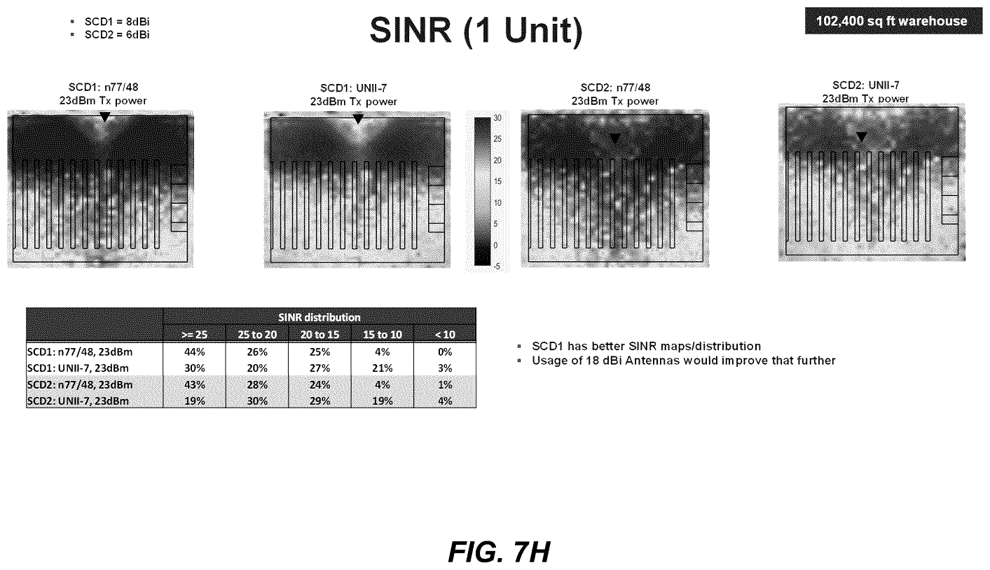

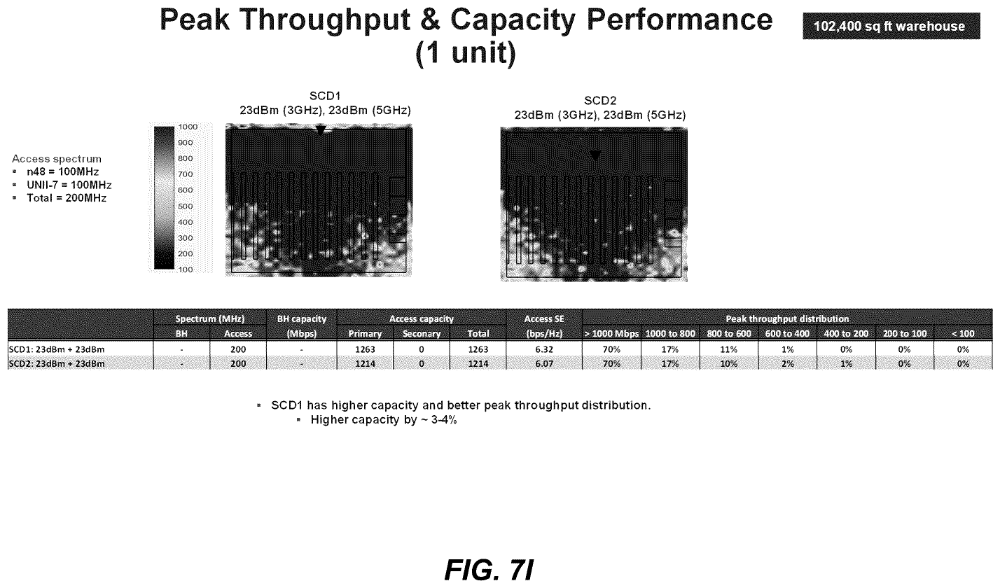

FIGS. 7A, 7B, 7C, 7D, 7E, 7E, 7F, 7G, 7H, and 7I show results and other information related to various computer simulations of access point devices within different room or building configurations in accordance with embodiments described herein. In various ones of FIGS. 7A, 7B, 7C, 7D, 7E, 7E, 7F, 7G, 7H, and 7I, triangles indicate locations of simulated access point devices. It is noted that some of FIGS. 7A, 7B, 7C, 7D, 7E, 7E, 7F, 7G, 7H, and 7I (e.g., FIG. 7F) do not show triangles or do not show them clearly. Simulations predicting Reference Signals Received Power (RSRP) and Signal to Interference and Noise Ratio (SINR) footprints have been conducted using narrow beam n77/48, narrow beam UNII-7, wide beam n77/48, wide beam UNII-7. Also, simulations were performing based on two different small cell devices, SCD1 and SCD2. Results of those simulations indicate that different techniques can be used to optimize frequency reuse of 1, including power control and fractional reuse.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A system including:
a primary access point device which, in operation, simultaneously communicates using a first unlicensed frequency band and a second unlicensed frequency band; and
a secondary access point device which, in operation, receives timing information from the primary access point device using the first unlicensed frequency band and communicates with the primary access point device based on the timing information.

2. The system according to claim 1, wherein:
the first unlicensed frequency band is a General Authorized Access (GAA) frequency band; and
the second unlicensed frequency band is an Unlicensed National Information Infrastructure (U-NII) frequency band.

3. The system according to claim 2, wherein:
the GAA frequency band is an n48 GAA frequency band, and
the U-NII frequency band is an n96 frequency band.

4. The system according to claim 2, wherein the primary access point device, in operation, performs carrier aggregation of at least one carrier frequency included the GAA frequency band and at least one carrier frequency included the U-NII frequency band.

5. The system according to claim 4, wherein the primary access point device, in operation, performs carrier aggregation of one carrier frequency included the GAA frequency band and two carrier frequencies included the U-NII frequency band.

6. The system according to claim 4, wherein the primary access point device, in operation, performs carrier aggregation of one carrier frequency included the GAA frequency band and one carrier frequency included the U-NII frequency band.

7. The system according to claim 4, wherein the primary access point device, in operation, performs carrier aggregation of one carrier frequency included the GAA frequency band and three carrier frequencies included the U-NII frequency band.

8. The system according to claim 1, wherein the secondary access point device, in operation, communicates using a first licensed frequency band and a second licensed frequency band.

9. The system according to claim 8, wherein:
the first licensed frequency band is a first Priority Access License (PAL) frequency band; and
the second licensed frequency band is a second PAL frequency band different from the first PAL frequency band.

10. The system according to claim 9, wherein:
the first PAL frequency band is an n77 PAL frequency band, and
the second PAL frequency band is an n48 PAL frequency band.

11. The system according to claim 9, wherein the primary access point device, in operation, performs carrier aggregation of at least one carrier frequency included the first PAL frequency band and at least one carrier frequency included the second PAL frequency band.

12. The system according to claim 9, wherein the primary access point device, in operation, performs carrier aggregation of at least one carrier frequency included the first PAL frequency or the second PAL frequency band and at least one carrier and included in an Unlicensed National Information Infrastructure (U-NII) frequency band.

13. The system according to claim 1, wherein the primary access point device, in operation, simultaneously communicates with the secondary access point device using the first unlicensed frequency band and the second unlicensed frequency band.
